(19) United States
(12) Patent Application Publication
(10) Pub. No.: US 2017/0054745 A1
(43) Pub. Date: Feb. 23, 2017

(54) METHOD AND DEVICE FOR PROCESSING NETWORK THREAT

(71) Applicant: BEIJING QIHOO TECHNOLOGY COMPANY LIMITED, Beijing (CN)

(72) Inventors: Cong ZHANG, Beijing (CN); Zhuo ZHANG, Beijing (CN)

(21) Appl. No.: 15/119,598

(22) PCT Filed: Dec. 30, 2014
(86) PCT No.: PCT/CN2014/095678

§ 371 Date: Aug. 17, 2016

(30) Foreign Application Priority Data
Feb. 17, 2014 (CN) 201410053974.6

(51) Int. Cl. H04L 29/06; H04L 29/08

(52) U.S. Cl. CPC H04L 63/1425; H04L 67/06; H04L 63/1416

(57) ABSTRACT

The invention provides a method and device for processing a network threat. The method comprises: listening for a network access behavior of a network device and acquiring a network datagram; analyzing the acquired network datagram to extract metadata; and detecting the metadata and determining an attack behavior, wherein the attack behavior comprises a known attack behavior and/or an unknown attack behavior. By employing the method for processing a network threat provided by embodiments of the invention, new network threats, including known attack behaviors and unknown attack behaviors, can be found and processed in time, achieving the beneficial effect of ensuring that the network is free from security threats.

### FIELD OF THE INVENTION

The invention relates to the field of internet applications, and in particular, to a method and device for processing a network threat.

### BACKGROUND OF THE INVENTION

With the development of the information society, network information security increasingly goes deep into people's lives. Frequent occurrence of information security incidents such as information leakage, data loss, and user privacy leakage, etc. will give rise to great economic loss, and will have a significant adverse effect on the society. Or even, information security incidents will endanger the national security. For example, in 2012, our secret unit found a malicious code which had lurked for seven years, and in May, 2013, multiple South Korea's banks and TV stations encountered hacker attacks and the network was paralyzed over a large area.

With the development of science and technology, network threats have new characteristics. New network threats gradually realize a property transformation from practical jokes to commercial interests, a sponsor transformation from individuals to gang organizations, and a technological transformation from common viruses/Trojans to advanced persistent threats (APT for short hereinafter). These transformations cause the network information security to suffer a greater threat. For a new network threat, not only its means is covert, but also the security defense system in the prior art can not grasp its vulnerability and technique. Therefore, the traditional security defense system can not take corresponding technical means to solve the new network threat, which results in that information on people's production and lives suffers more serious security threats, and yet once these security threats happen in reality, a devastating impact which it is difficult to estimate will be caused to the economy, the society, or even the national security.

### SUMMARY OF THE INVENTION

In view of the above problems, the invention is proposed to provide a method for processing a network threat and a corresponding device, which overcome the above problems or at least in part solve the above problems.

According to an aspect of the invention, there is provided a method for processing a network threat comprising: listening for a network access behavior of a network device and acquiring a network datagram; analyzing the acquired network datagram to extract metadata; and detecting the metadata and determining an attack behavior, wherein the attack behavior comprises a known attack behavior and/or an unknown attack behavior.

According to another aspect of the invention, there is further provided a device for processing a network threat comprising: a listening module configured to listen for a network access behavior of a network device and acquire a network datagram; a data extraction module configured to analyze the acquired network datagram to extract metadata; and a determination module configured to detect the metadata and determine an attack behavior, wherein the attack behavior comprises a known attack behavior and/or an unknown attack behavior.

According to still another aspect of the invention, there is provided a computer program comprising a computer readable code which causes a computing device to perform the method for processing a network threat described above, when said computer readable code is running on the computing device.

According to yet still another aspect of the invention, there is provided a computer readable medium storing therein the computer program as described above.

According to the method for processing a network threat provided by embodiments of the invention, it can be possible to listen for a network access behavior of a network device, acquire a network datagram, extract metadata by analyzing the network datagram, and determine a known or unknown attack behavior according to detection of the metadata, which solves the problem in the prior art that the vulnerability and technique of a new network threat (comprising a known attack and an unknown attack) cannot be grasped, and then a corresponding technical means cannot be adopted to solve the new network threat. The method for processing a network threat provided by the embodiments of the invention acquires a network datagram by listening for a network access behavior of a network device in real time, can find out information such as a vulnerability attack of an unknown attack and the covert channel of the unknown attack, etc. dynamically according to the acquired network datagram, and can detect the unknown attack rapidly. In addition, the embodiments of the invention store the acquired network datagram to form historical data of a big data level, and perform analysis & mining on the big data, and then can detect an advanced covert attack, which is an effective means of performing supplementary detection on an attack missed due to the limitations of the prior art. From the above, by employing the method for processing a network threat provided by the embodiments of the invention, a new network threat, including a known attack behavior and an unknown attack behavior, can be found in time, and then a user is enabled to take a processing measure for the found new network threat, achieving the beneficial effect of ensuring that the people's production and lives and even the national security are free from network information security threats.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a processing flow chart of a method for processing a network threat according to an embodiment of the invention;

FIG. 2 shows a structural diagram of a “sky-eye system” composed of a local detection engine and a cloud detection engine according to an embodiment of the invention;

FIG. 3 shows a processing flow chart of a method for processing a network threat according to a preferred embodiment of the invention;

FIG. 4 shows a processing flow chart of processing a network datagram by a real-time analysis module;

FIG. 5 shows a processing flow chart of processing data parsed by individual protocols by a real-time analysis module according to a preferred embodiment of the invention;

FIG. 6 shows a flow chart of detecting a file utilizing a sandbox detection mode according to an embodiment of the invention;

FIG. 7 shows a flow chart of detecting a file utilizing a sandbox detection mode according to a preferred embodiment of the invention;

FIG. 8 shows a structural flow chart after combining a real-time analysis module and a sandbox detection module according to an embodiment of the invention;

FIG. 9 shows a processing flow chart of a known/unknown attack detection module according to an embodiment of the invention;

FIG. 10 shows a processing flow chart of an attack detection & backtracking module which is based on big data analysis according to an embodiment of the invention;

FIG. 11 shows a flow chart of establishing a network abnormal behavior model and determining an attack behavior accordingly according to a preferred embodiment of the invention;

FIG. 12 shows a structural diagram of threat perception according to a preferred embodiment of the invention;

FIG. 13 shows a schematic diagram of an interface of a file alarm, behavior alarm and mail alarm at the time of comprehensive detection according to an embodiment of the invention;

FIG. 14 shows an interface diagram of detailed alarm information of a file alarm according to an embodiment of the invention;

FIG. 15 shows an interface diagram of alarm analysis of alarm information according to an embodiment of the invention;

FIG. 16 shows a log report form of analysis of alarm information according to an embodiment of the invention;

FIG. 17 shows an interface diagram of user management according to an embodiment of the invention;

FIG. 18 shows an interface diagram of configuration management according to an embodiment of the invention;

FIG. 19 shows a structural diagram of a device for processing a network threat according to an embodiment of the invention;

FIG. 20 shows schematically a block diagram of a computing device for performing a method for processing a network threat according to the invention; and

FIG. 21 shows schematically a storage unit for retaining or carrying a program code implementing a method for processing a network threat according to the invention.

### DETAILED DESCRIPTION OF THE INVENTION

In the following the invention will be further described in connection with the drawings and the particular embodiments.

It is mentioned in the related art that for a new network threat, not only its means is covert, but also the security defense system in the prior art can not grasp its vulnerability and technique. Therefore, the traditional security defense system can not take corresponding technical means to solve the new network threat, which results in that information on people's production and lives suffers more serious security threats, and yet once these security threats happen in reality, a devastating impact which it is difficult to estimate will be caused to the economy, the society, or even the national security.

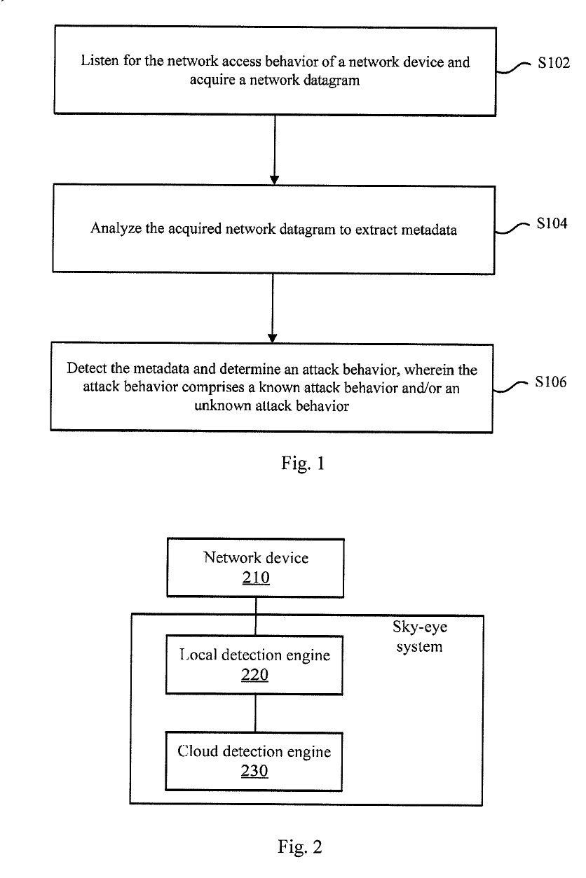

To solve the above technical problem, an embodiment of the invention proposes a method for processing a network threat. FIG. 1 shows a processing flow chart of a method for processing a network threat according to an embodiment of the invention. Referring to FIG. 1, the flow comprises at least step S102 to step S106.

At the step S102, the network access behavior of a network device is listened and a network datagram is acquired.

At the step S104, the acquired network datagram is analyzed to extract metadata.

At the step S106, the metadata is detected and an attack behavior is determined, wherein the attack behavior comprises a known attack behavior and/or an unknown attack behavior.

According to the method for processing a network threat provided by the embodiment of the invention, it can be possible to listen for the network access behavior of a network device, acquire a network datagram, extract metadata by analyzing the network datagram, and determine a known or unknown attack behavior according to detection of the metadata, which solves the problem in the prior art that the vulnerability and technique of a new network threat (comprising a known attack and an unknown attack) cannot be grasped, and then a corresponding technical means cannot be adopted to solve the new network threat. The method for processing a network threat provided by the embodiment of the invention acquires a network datagram by listening for the network access behavior of a network device in real time, can find out information such as a vulnerability attack of an unknown attack and the covert channel of the unknown attack, etc. dynamically according to the acquired network datagram, and can detect the unknown attack rapidly. In addition, the embodiment of the invention stores the acquired network datagram to form historical data of a big data level, and performs analysis & mining on the big data, and then can detect an advanced covert attack, which is an effective means of performing supplementary detection on an attack missed due to the limitations of the prior art. From the above, by employing the method for processing a network threat provided by the embodiment of the invention, a new network threat, including a known attack behavior and an unknown attack behavior, can be found in time, and then a user is enabled to take a processing measure for the found new network threat, achieving the beneficial effect of ensuring that the people's production and lives and even the national security are free from network information security threats.

It is mentioned in the above that embodiments of the invention can detect an attack behavior of a network threat and process it in time. As shown in FIG. 2, the embodiments of the invention can be applied in a local detection engine 220, and combined with a cloud detection engine 230 in the prior art to constitute a “sky-eye system” (wherein the “sky-eye” is just a system name, and does not have any impact on the functions, attributes and roles, etc. of the system composed of the local detection engine and the cloud detection engine), which performs detection processing on a network access behavior in a network device 210, finds a network threat (comprising a network attack behavior, etc.) therein, achieves “Justice has long arms” for the network threat, and processes the network threat more comprehensively, extensively and particularly.

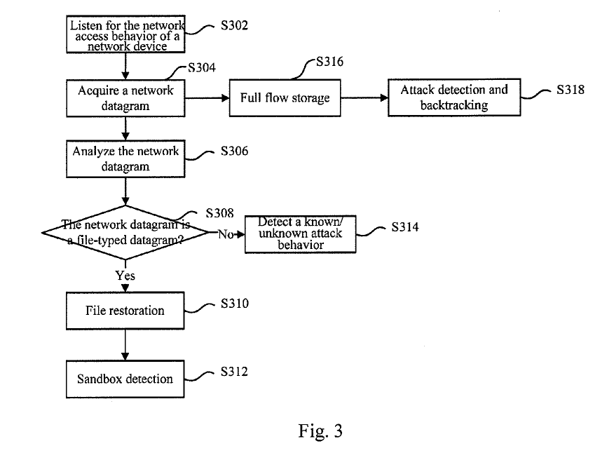

Now, the method for processing a network threat which is applied in the local detection engine 220 is taken as an example to introduce a method for processing a network threat provided by an embodiment of the invention. FIG. 3 shows a processing flow chart of a method for processing a network threat according to a preferred embodiment of the invention. Firstly, step S302 is performed to listen for the network access behavior of a network device. In the procedure of listening, step S304 is performed in real time, to acquire a network datagram. In the embodiment of the invention, listening for the network access behavior of a network device can monitor the network access behavior of the network device in real time, and ensure that the network access behavior of the network device is acquired in time. Further, it can be ensured that before any attack behavior takes place, the embodiment of the invention can detect the attack behavior in time and perform reasonable and effective processing, which ensures the network security. Therefore, the embodiment of the invention listens for the network access behavior of the network device in the whole network threat processing flow, and performs the step S304 in real time to acquire a network datagram.

After a network datagram is acquired, step S306 is performed to analyze the network datagram. In an embodiment of the invention, analysis of the acquired network datagram may be to analyze the source network address of the network datagram, or also may be to analyze the destination address of the network datagram. Preferably, in an embodiment of the invention, to be able to detect and process an attack behavior in the network datagram accurately in subsequent operations, the acquired network datagram is classified when analyzing the acquired network datagram. Moreover, for each class, the embodiment of the invention selects a corresponding policy to detect an attack behavior. When classifying the acquired network datagram, an embodiment of the invention may classify the network datagram according to the source address or the destination address or any other information, and select a corresponding policy to detect an attack behavior according to the classification result. Since according to the data of a network datagram, the network datagram can be classified more comprehensively and accurately, preferably, in an embodiment of the invention, acquired data is divided into a file-typed datagram and/or a non-file-typed datagram according to the attributes of individual network datagrams. That is, according to analysis of the acquired network datagram, the network datagram may be a file-typed datagram, may be a non-file-typed datagram, or also may be a combination of a file-typed datagram and a non-file-typed datagram.

After the network datagram is classified, step S308 as shown in FIG. 3 is performed to determine whether the network datagram is a file-typed datagram. If yes, step S310 is performed to restore the determined file-typed datagram to a file. Afterwards, the restored file is detected, to detect whether the file has a malicious behavior. In the procedure of detecting the file, to ensure that the detected file is completely isolated from programs which are running, and in turn to ensure that the detected file will not exhibit an attack behavior in the procedure of detection, an embodiment of the invention utilizes a sandbox detection mode to detect the restored file, as shown at step S312 in FIG. 3. Therein, the way of detecting the file comprises: detecting whether the file has a malicious behavior based on the principle of network abnormal behavior detection. If the network datagram is a non-file-typed datagram according to the judgment result of the step S308, step S314 is directly performed to detect a known attack behavior and/or unknown attack behavior based on the principle of network abnormal behavior detection. When the network datagram is a combination of a file-typed datagram and a non-file-typed datagram, the network datagram is divided into a file-typed datagram part and a non-file-typed datagram part, and operations are performed according to the steps mentioned above, respectively, which will not be repeated here.

In addition, as shown at step S316 in FIG. 3, in an embodiment of the invention, after the network datagram is acquired, in addition to analyzing the acquired network datagram, the embodiment of the invention may further perform full flow storage for a captured network datagram (i.e., the step S316), to ensure that a historical network datagram can be acquired in time for comparison in a subsequent analysis, so as to analyze a network datagram at a deeper level and achieve a more efficient performance of processing a network threat. Moreover, when the order of magnitude of the stored network datagrams arrives at a big data level, an embodiment of the invention performs attack detection of big data analysis on the stored network datagrams to determine an attack behavior, and/or for a determined attack behavior, performs backtracking on the attack behavior based on big data analysis. Preferably, in an embodiment of the invention, the operation of performing backtracking on the attack behavior based on big data analysis may be any one or several operations that can analyze the attack behavior, such as locating an attack source of the attack behavior, restoring an access behavior corresponding to the attack behavior, and restoring access content corresponding to the attack behavior, and the like, which will not be defined by the embodiment of the invention.

After detecting metadata and determining an attack behavior according to the processing flow of the method for processing a network threat as shown in FIG. 3, an embodiment of the invention may further upgrade a security means used on the network device according to an unknown attack behavior, such that the security means used on the network device can defend against the unknown attack behavior. Moreover, in this document, it has been mentioned that a local detection engine and a cloud detection engine can constitute a “sky-eye system” to perform detection processing on a network threat in a network device (for details, reference is made to FIG. 2 and its corresponding description). It needs to be noted that an embodiment of the invention can detect metadata and determine an attack behavior via the local detection engine and/or the cloud detection engine.

In the above, a method for processing a network threat provided by an embodiment of the invention has been introduced according to the flow chart as shown in FIG. 3. Now, a preferred embodiment will be used to further introduce several modules in the method for processing a network threat provided by the embodiment of the invention, in order to more deeply and clearly set forth the method for processing a network threat provided by the embodiment of the invention. In particular, a real-time analysis module (of which the implementation function is referred to the part for analyzing the network datagram mentioned at the step S306 as shown in FIG. 3), a sandbox detection module (of which the implementation function is referred to the sandbox detection part mentioned at the step S312 as shown in FIG. 3), a known/unknown attack detection module (of which the implementation function is referred to the part for detecting a known/unknown attack behavior mentioned at the step S314 as shown in FIG. 3) and an attack detection & backtracking module which is based on big data analysis (of which the implementation function is referred to attack detection & backtracking part mentioned at the step S318 as shown in FIG. 3) in the method for processing a network threat provided by the embodiment of the invention will be introduced now.

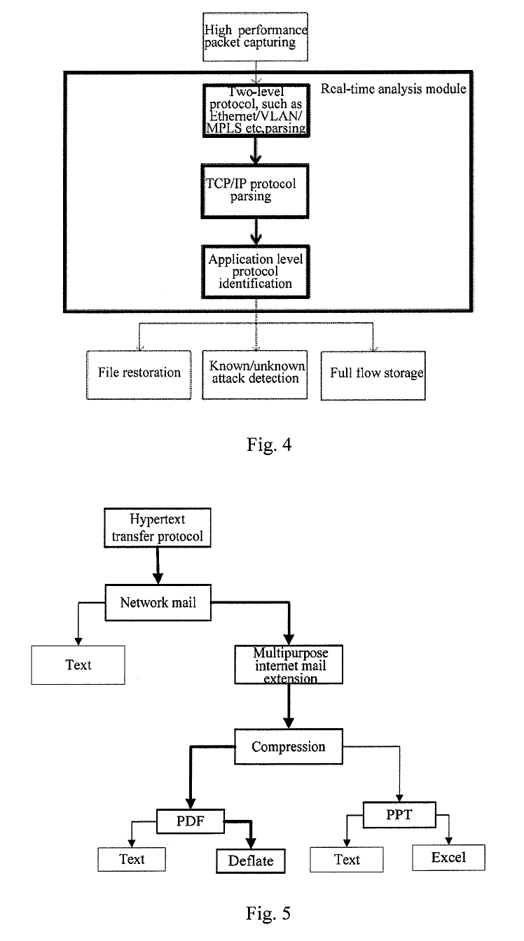

First, the real-time analysis module will be introduced. FIG. 4 shows a processing flow chart of processing a network datagram by a real-time analysis module. After receiving a network datagram captured by a high-performance packet capturing flow, the real-time analysis module first performs parsing by any two-level protocol such as Ethernet/VLAN (Virtual LAN)/MPLS (Multiprotocol Label Switching), etc. on the network datagram. Second, parsing by TCP/IP (abbreviation for Transmission Control Protocol/Internet Protocol, also called Network Communication Protocol) protocol is further performed on the data packet parsed out by the previous step. Finally, recognition by application level protocol is performed on the data parsed out by the TCP/IP protocol. After finishing parsing the network datagram, the real-time analysis module performs subsequent processing on it, for example, file restoration, known/unknown attack detection and full flow storage in FIG. 4 are all steps of the subsequent processing.

FIG. 5 shows a processing flow chart of processing data parsed by individual protocols by a real-time analysis module according to a preferred embodiment of the invention. The preferred embodiment is an embodiment in which the content of a webmail (i.e., network mail) is parsed. As shown in FIG. 5, after parsed by the Hypertext Transfer Protocol, the application is recognized to be a network mail, and then the network mail is parsed to obtain a text and an MIME (i.e., Multipurpose Internet Mail Extension) for supporting additional data (e.g., a sound file, a video file, etc.) in the mail. Therein, the text file is metadata which can be detected directly, whereas for the MIME, it needs to be further parsed. The MIME part that needs to continue to be parsed is decompressed to obtain files of different formats, for example, a file of the portable document format (PDF for short hereinafter) and a file of the PPT (a kind of presentation software designed by the Microsoft Corporation) format as shown in FIG. 5. Therein, the further parsing of the file of the PPT format can obtain detectable metadata, for example, a text file and a file of the Excel (a kind of spreadsheet software) format as shown in FIG. 5. However, when parsing the file of the PDF format, a text file that can be detected directly and a file of the Deflate (a lossless data compression algorithm) format that cannot be detected directly are obtained. For the file of the Deflate format, it needs to be further parsed, until all the detectable metadata is obtained, and the real-time parsing is finished. It needs to be noted that, in FIG. 5, the thicker arrows point to an extended real-time parsing path and the metadata of the network datagram can be extracted finally according to the real-time parsing path.

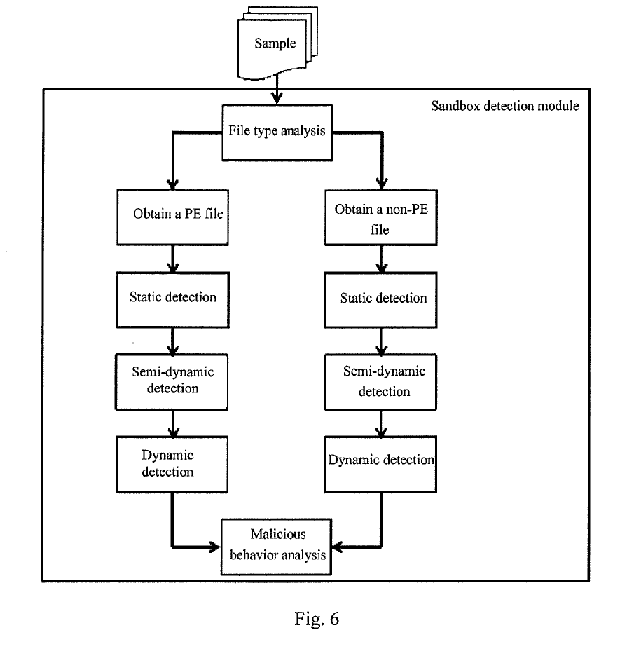

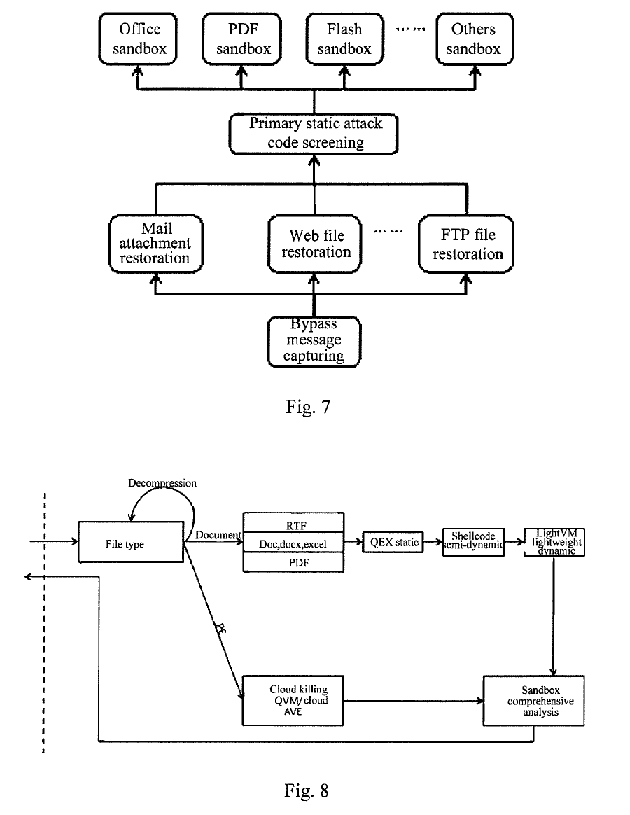

Next, the sandbox detection module will be introduced. FIG. 6 shows a flow chart of detecting a file utilizing a sandbox detection mode according to an embodiment of the invention. After the network datagram (i.e., the sample in FIG. 6) is acquired, the file type of the network datagram is first analyzed, and a portable execute file (PE file for short hereinafter) and/or a non-portable execute file (non-PE file for short hereinafter) are/is obtained. Procedures of static detection, semi-dynamic detection and dynamic detection are performed on the PE file and the non-PE file, respectively, and malicious behavior analysis is conducted according to the detection results. FIG. 7 shows a flow chart of detecting a file utilizing a sandbox detection mode according to a preferred embodiment of the invention. As shown in FIG. 7, after the network datagram is acquired, if it is judged that the acquired network datagram is a file-typed datagram, the file-typed datagram is restored to a file, for example, the mail attachment restoration, the web (network) file restoration and the FTP (File Transfer Protocol) file restoration, etc. shown in FIG. 7. After the restoration, primary static attack code screening is performed on the file, i.e., the procedure of static detection of the file in FIG. 6.

After the static detection is finished, if an attack code is detected, it is determined that the file has a malicious behavior, and then corresponding processing is conducted. If a static attack code is not detected, semi-dynamic and dynamic detection is performed on the file utilizing a sandbox. As shown in FIG. 7, restored files of applications, for example, restored files of Office (a piece of office software of the Microsoft Corporation), PDF, Flash (a kind of authoring software setting animation creation and application development in one) and any other application are placed in the sandbox for detection. According to the sandbox detection, information about whether the restored file of an individual application has a malicious behavior can be acquired dynamically, and the degrees of suspicion of restored files of individual applications may be further acquired dynamically. For example, at 22:27:10 on Oct. 18, 2013, in a compressed file whose file name is “LaLa life website”, the degree of suspicion of an operation behavior that it starts a host process to inject a code is 4 stars, the degree of suspicion of an operation behavior that it sets the context of a remote thread is 3 stars, and the degree of suspicion of an operation behavior that it applies for a memory in other process is 1 star. Therein, the more the number of stars, the higher the degree of suspicion is, and the higher the possibility that its operation behavior is a malicious behavior. It needs to be noted that, the time, the software name, the file name and the evaluation method for the degree of suspicion, etc. are all examples, and cannot represent various information details that can appear in a practical application.

FIGS. 4-7 and corresponding text descriptions of the individual figures introduce a real-time analysis module and a sandbox detection module. FIG. 8 shows a structural flow chart after combining a real-time analysis module and a sandbox detection module according to an embodiment of the invention. With reference to FIG. 8, detectable metadata is obtained by decompressing the file. Therein, if the file is a PE file, cloud killing is first performed on the file, for example, using a Qihoo Support Vector Machine (QVM for short hereinafter) or a cloud AVE (Audio Video Engine). For a PE file that passes the cloud killing, the sandbox (i.e., Sandbox in FIG. 8) detection mode is utilized to perform complete analysis and detection. For a non-PE file, for example, the Rich Text Format (RTF format for short hereinafter), the PDF format, the Doc (a file extension) format, the docx (a file extension) format and the excel format, etc. as shown in FIG. 8, if the file is a document that can continue to be decompressed, then the flow returns to continue to perform a decompression operation, and if the file is detectable metadata, QEX static analysis, filling data (shellcode) semi-dynamic detection and lightVM lightweight dynamic analysis are conducted. Afterwards, sandbox detection is utilized to detect again the metadata that passes the above three kinds of detection. When detecting whether the file has a malicious behavior, preferably, in an embodiment of the invention, the danger level of a malicious behavior may be divided in to three levels: a first level, high danger, i.e., at which the metadata can be confirmed as a malicious code, e.g., a determined Trojan sample, an evident malicious behavior or vulnerability utilization that can be triggered, or the like; a second level, medium danger, i.e., at which a suspected malicious behavior exists, but it cannot be determined, or suspected vulnerability utilization exists, but the malicious behavior has not yet been determined, for example, it is found that a sample will access the following sensitive location, or a sample will cause a program to crash, but has not triggered execution; and a third level, low danger, i.e., at which a non-malicious file that has not been confirmed may endanger the system security, and may be understood as a file which has a risk.

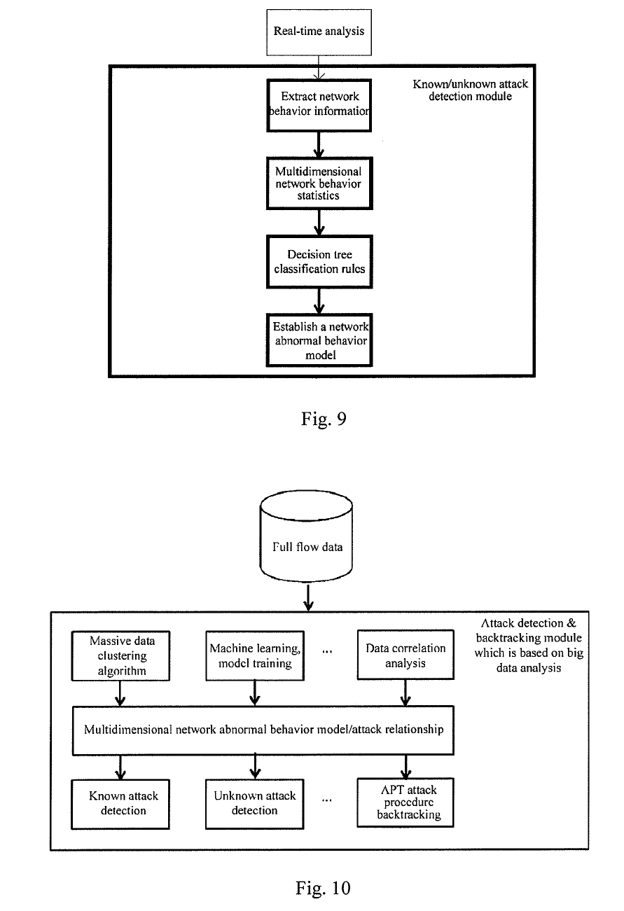

After finishing introduction of the real-time analysis module and the sandbox detection module, the known/unknown attack detection module will be introduced. After the acquired network datagram is judged to be a non-file-typed datagram, an embodiment of the invention detects a known/unknown attack behavior based on the principle of network abnormal behavior detection. As shown in FIG. 9, first, extraction of network behavior information is performed on the metadata extracted from the network datagram (which is obtained by the above real-time analysis). Second, multidimensional network behavior statistics is conducted on the extracted network behavior information. Afterwards, according to the statistical result, a network abnormal behavior model is established utilizing decision tree classification rules, and the network abnormal behavior model is used to determine an attack behavior.

In addition, when conducting the above mentioned establishment of a network abnormal behavior model, an embodiment of the invention uses stored network datagrams. It is mentioned when introducing a method for processing a network threat provided by an embodiment of the invention, that in an embodiment of the invention, full flow storage is performed for the captured network datagram, and when the order of magnitude of the stored network datagrams arrives at big data level, for a determined attack behavior, the attack behavior may be backtracked based on big data analysis. Therefore, in the following, first, the attack detection & backtracking module which is based on big data analysis will be introduced, and second, that stored network datagrams are used to establish a network abnormal behavior model will be introduced.

In the attack detection & backtracking module which is based on big data analysis as shown in FIG. 10, an embodiment of the invention performs full flow storage for a captured network datagram to obtain full flow data, for example, network access record information, all internal and external web access requests of the network, and a network or mail transferred file. When implemented, the clustering algorithm may be employed to analyze the full flow data, machine learning and rule extraction operations may be performed on the full flow data, or also a data correlation analysis operation may be performed on the full flow data, or the like. By the above multidimensional network behavior analysis statistics, a network abnormal behavior model can be established, and an attack relationship can be determined. Then, an operation of known attack detection, unknown attack detection and APT attack procedure backtracking, etc. can be performed by the established network abnormal behavior model and the determined attack relationship.

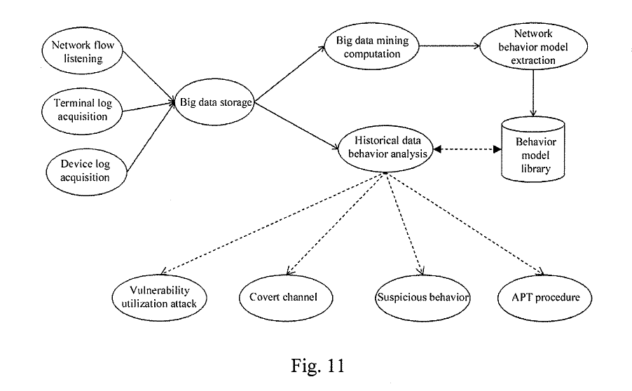

After introducing the attack detection & backtracking module which is based on big data analysis, FIG. 11 shows a flow chart of establishing a network abnormal behavior model and determining an attack behavior accordingly according to a preferred embodiment of the invention. As shown in FIG. 11, a network datagram can be acquired by a behavior of listening for the network flow, acquiring a terminal log and acquiring a device log, and the like. Full flow storage is performed for the acquired network datagram. When the order of magnitude of the stored network datagrams arrives at the big data level, big data mining computation and historical data behavior analysis are conducted. Therein, the analysis result obtained after behavior analysis is conducted for the historical data can be added into a behavior model library for use for subsequent analysis, whereas a network behavior model can be extracted by big data mining computation, and also the extracted network behavior model may be added into the behavior model library. In addition, the behavior model library can in turn be taken as historical data of the historical data behavior analysis. By the historical data behavior analysis, information of an unknown attack such as a vulnerability utilization attack, suspicious behavior, APT procedure and covert channel, etc. can be acquired. Further, a known or unknown attack behavior can be detected and determined.

For example, in an embodiment of this application, a server receives an active access of a client, and provides various response services for the client. The server will only actively initiate an access behavior in limited situations, for example, to acquire a system patch, and the like. If in a listened flow, the server actively accesses a European DNS (Domain Name System) server, then the access operation of the server is inconsistent with its historical data behaviors, which shows that a suspicious behavior exists, and further detection needs to be performed.

In the above, a method for processing a network threat provided by an embodiment of the invention and specific module information therein have been introduced. To elaborate a method for processing a network threat provided by an embodiment of the invention more intuitively and clearly, now, a specific embodiment will be provided.

### Embodiment One

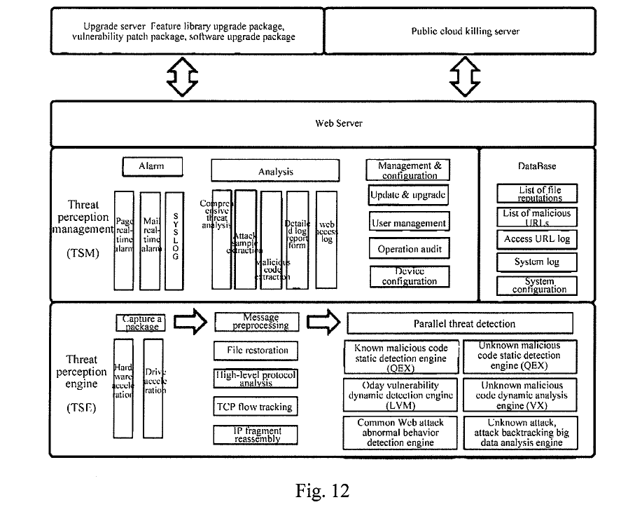

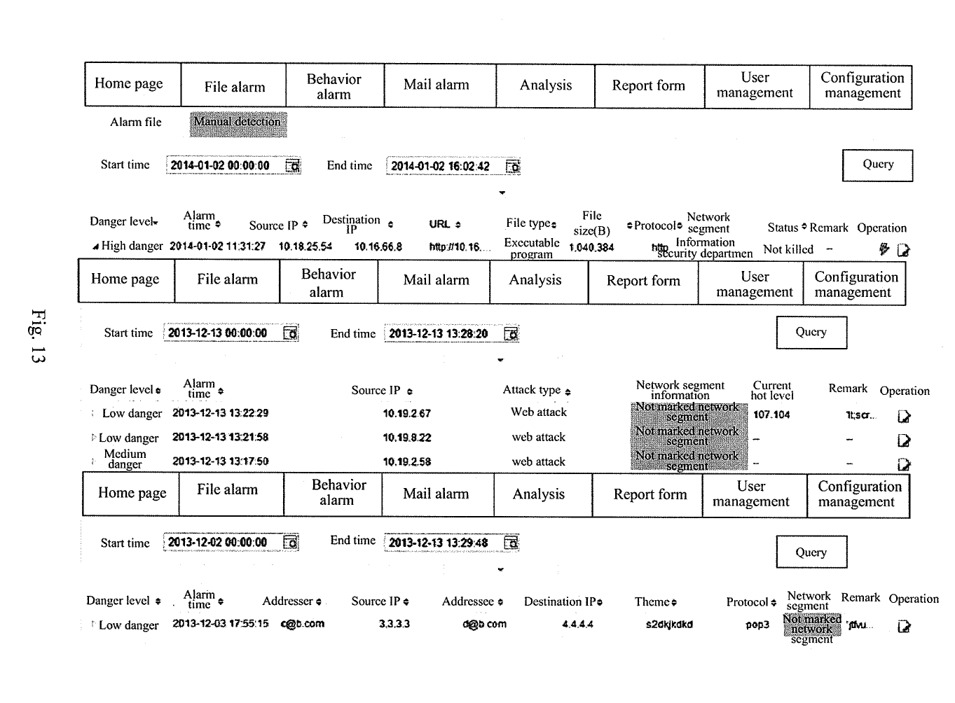

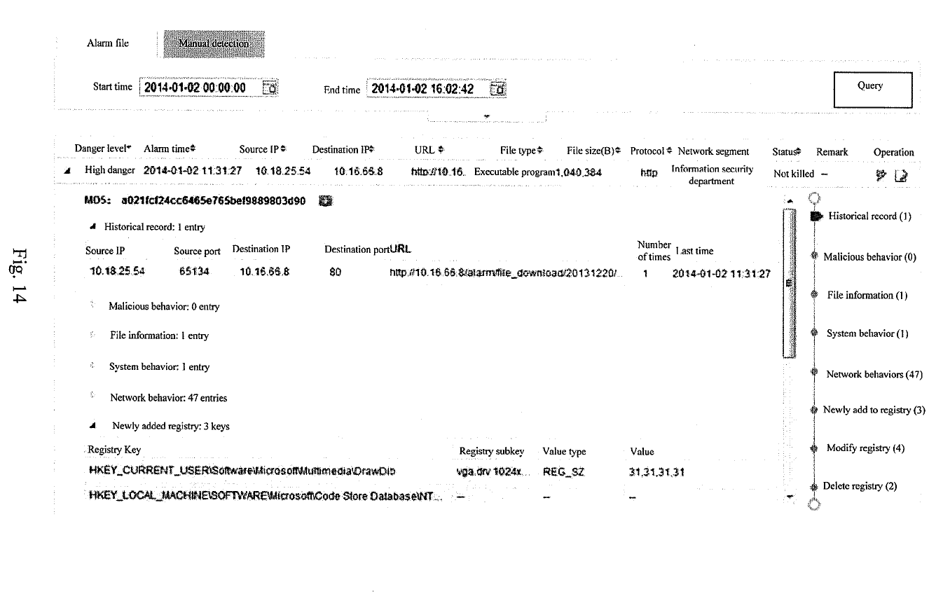

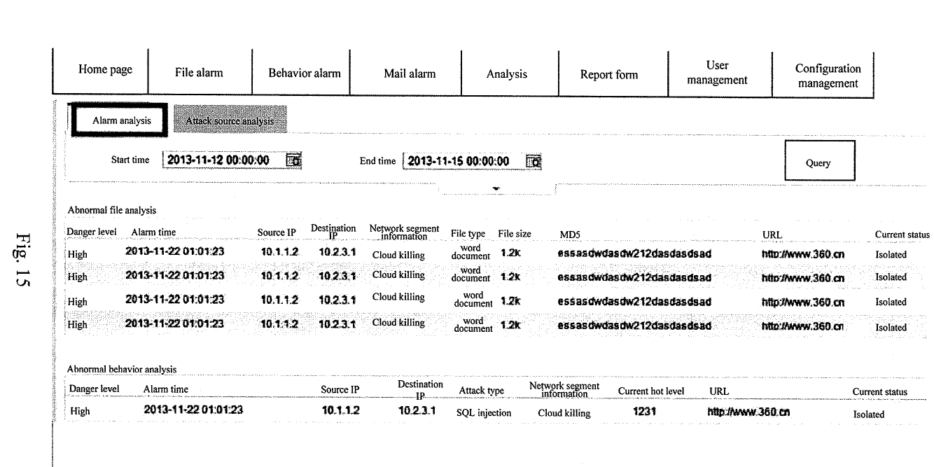

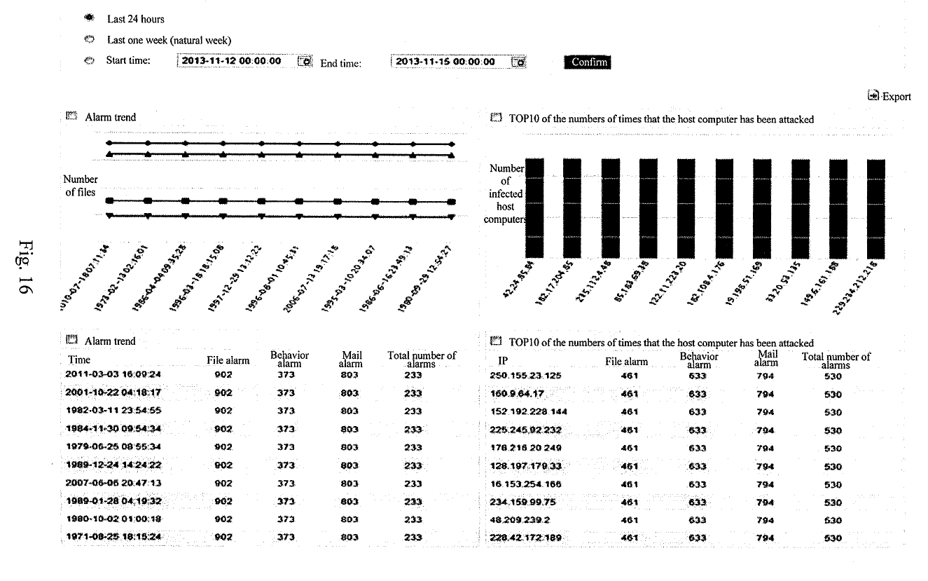

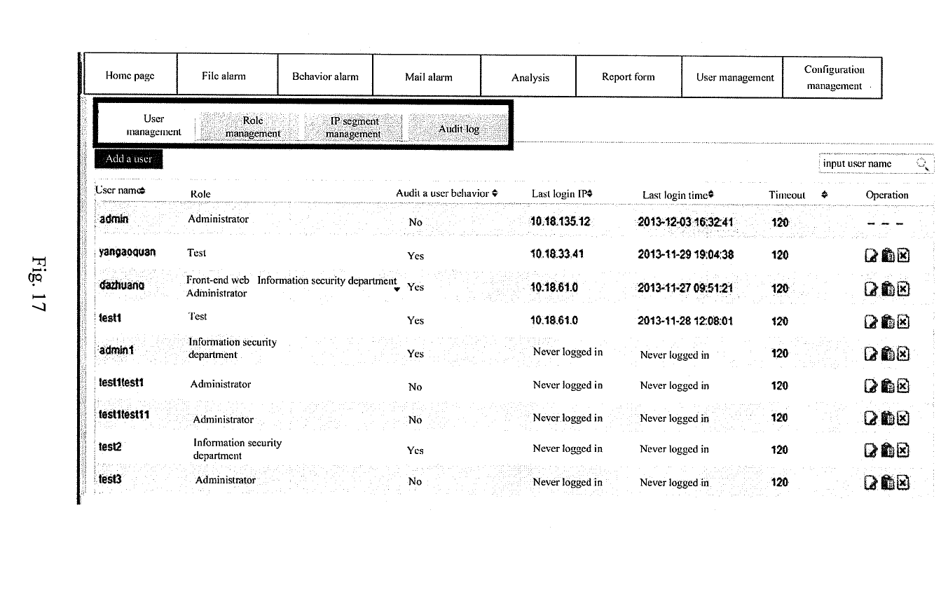

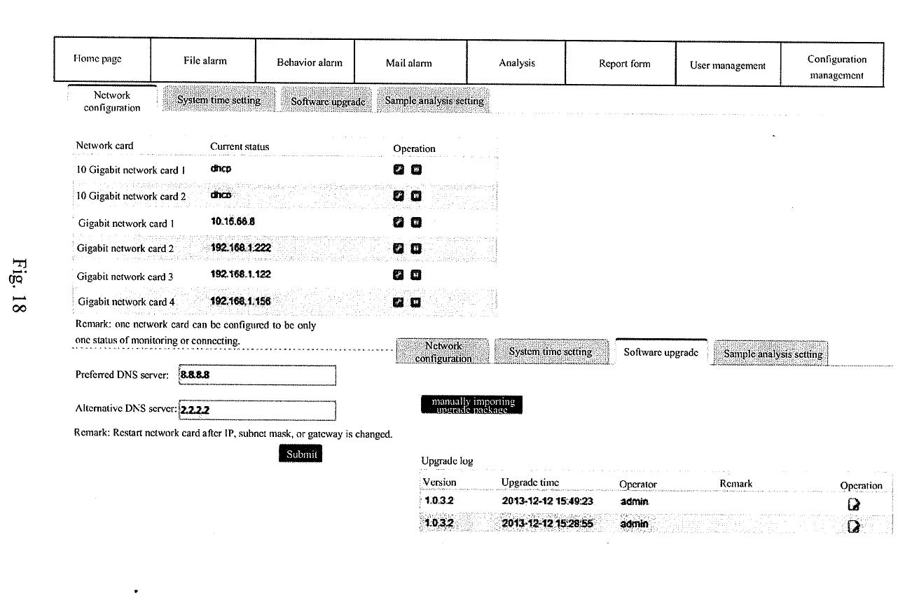

FIG. 12 shows a structural diagram of threat perception according to a preferred embodiment of the invention. With reference to FIG. 12, an embodiment of the invention performs threat perception management by combining a local detection engine (e.g., feature library upgrade package, vulnerability patch package and software upgrade package) and a cloud detection engine. Therein, threat perception management performed by means of a Total Solution Maintenance (TSM for short hereinafter) system comprises alarm, analysis, management and configuration as well as a data source (DataBase). And yet threat perception management performed by means of a Tiny Search Engine (TSE for short hereinafter) comprises capturing a package, message preprocessing and parallel threat detection. FIG. 13 to FIG. 18 show different interface diagrams of processing a network threat according to an embodiment of the invention, respectively. Therein, FIG. 13 shows a schematic diagram of an interface of a file alarm, behavior alarm and mail alarm at the time of comprehensive detection. In the alarm interface diagram of the embodiment, a user is prompted for information about the danger level, alarm time, etc. of the file or behavior or mail that is alarmed currently. FIG. 14 shows an interface diagram of detailed alarm information of a file alarm according to an embodiment of the invention. As shown in FIG. 14, in the interface, a user can know information on the danger level, the alarm time, the source network internet protocol (IP for short hereinafter) address, the destination IP address, the file type, the file size of the file, and the historical record about the file, etc., which is convenient for a user to know detailed information about a file that has a threat, and further make corresponding judgment and processing. FIG. 15 shows an interface diagram of alarm analysis of alarm information according to an embodiment of the invention. As shown in FIG. 15, the embodiment of the invention can conduct comprehensive analysis and effective location for an unknown threat or attack behavior based on a lot of detected abnormal alarm information. FIG. 16 shows a log report form of analysis of alarm information according to an embodiment of the invention. As shown in FIG. 16, a user can look up the alarm trend of the network access behavior in a different period of time according to different time. As shown in FIG. 16, the user can look up the alarm trend and the top 10 of the numbers of times that a host computer has been attacked in the last 24 hours, and a statistical chart corresponding to the alarm trend and the top 10 of the numbers of times that a host computer has been attacked. In addition, FIG. 17 shows an interface diagram of user management according to an embodiment of the invention, and FIG. 18 shows an interface diagram of configuration management according to an embodiment of the invention. From the above, embodiments of the invention can conduct personalized setting with different functions according to different users, further more efficiently help different users to perform network threat processing at different depths in different scopes, and enhance the user experience.

Based on the method for processing a network threat provided by the above individual preferred embodiments, and based on one and the same inventive concept, an embodiment of the invention provides a device for processing a network threat, which is used for the method for processing a network threat.

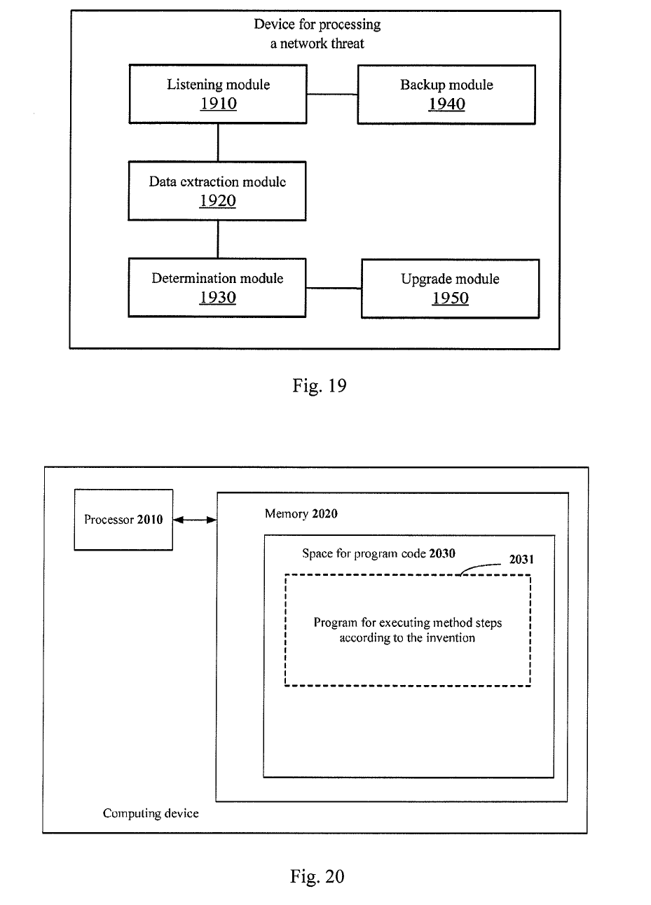

FIG. 19 shows a structural diagram of a device for processing a network threat according to an embodiment of the invention. With reference to FIG. 19, the device for processing a network threat of the embodiment of the invention comprises at least: a listening module 1910, a data extraction module 1920 and a determination module 1930.

Now, functions of individual devices or components and a connection relationship between individual parts of the device for processing a network threat of the embodiment of the invention will be introduced.

The listening module 1910 is configured to listen for the network access behavior of a network device and acquire a network datagram.

The data extraction module 1920 is coupled to the listening module 1910 and configured to analyze the acquired network datagram to extract metadata.

The determination module 1930 is coupled to the data extraction module 1920 and configured to detect the metadata and determine an attack behavior, wherein the attack behavior comprises a known attack behavior and/or an unknown attack behavior.

According to the method for processing a network threat provided by embodiments of the invention, it can be possible to listen for the network access behavior of a network device, acquire a network datagram, extract metadata by analyzing the network datagram, and determine a known or unknown attack behavior according to detection of the metadata, which solves the problem in the prior art that the vulnerability and technique of a new network threat (comprising a known attack and an unknown attack) cannot be grasped, and then a corresponding technical means cannot be adopted to solve the new network threat. The method for processing a network threat provided by the embodiments of the invention acquires a network datagram by listening for the network access behavior of a network device in real time, can find out a vulnerability attack of an unknown attack and the covert channel of the unknown attack, dynamically according to the acquired network datagram, and can detect the unknown attack rapidly. In addition, the embodiments of the invention store the acquired network datagram to form historical data of a large data level, and perform analysis & mining on the large data, and then can detect an advanced covert attack, which is an effective means of performing supplementary detection on an attack missed due to the limitations of the prior art. From the above, by employing the method for processing a network threat provided by the embodiments of the invention, a new network threat, including a known attack behavior and an unknown attack behavior, can be found in time, and then a user is enabled to take a processing measure for the found new network threat, achieving the beneficial effect of ensuring that the people's production and lives and even the national security are free from network information security threats.

In a preferred embodiment, the data extraction module 1920 is further configured to

classify the acquired network datagram; and

select a corresponding policy to detect an attack behavior for each class.

In a preferred embodiment, the data extraction module 1920 is further configured to divide acquired data into a file-typed datagram and/or a non-file-typed datagram according to the attributes of individual network datagrams.

In a preferred embodiment, the data extraction module 1920 is further configured to, for a file-typed datagram, restore it to a file; and

detect the restored file, to detect whether the file has a malicious behavior.

In a preferred embodiment, the data extraction module 1920 is further configured to utilize a sandbox detection mode to detect the restored file.

In a preferred embodiment, the data extraction module 1920 is further configured to

detect whether the file has a malicious behavior based on the principle of network abnormal behavior detection.

In a preferred embodiment, the data extraction module 1920 is further configured to,

for a non-file-typed datagram,

detect an attack behavior based on the principle of network abnormal behavior detection.

In a preferred embodiment, the data extraction module 1920 is further configured to extract network behavior information of metadata;

conduct multidimensional network behavior statistics for the network behavior information;

establish a network abnormal behavior model utilizing decision tree classification rules according to the statistical result; and

use the network abnormal behavior model to determine an attack behavior.

In a preferred embodiment, the device for processing a network threat further comprises:

a backup module 1940 configured to perform full flow storage for a captured network datagram for use for subsequent analysis.

In a preferred embodiment, the backup module 1940 is further configured to perform attack detection based on big data analysis on stored network datagrams to determine an attack behavior when the order of magnitude of the stored network datagrams arrives at big data level; and/or

for a determined attack behavior, backtrack the attack behavior based on big data analysis.

In a preferred embodiment, the operation of backtracking the attack behavior based on big data analysis comprises at least one of the following:

locating an attack source of the attack behavior;

restoring an access behavior corresponding to the attack behavior; and

restoring access content corresponding to the attack behavior.

In a preferred embodiment, the device for processing a network threat further comprises:

an upgrade module 1950 configured to, after detecting metadata and determining an attack behavior, upgrade a security means used on the network device according to an unknown attack behavior, such that it can defend against the unknown attack behavior.

In a preferred embodiment, after determining an attack behavior, alarm information (e.g., an attacked terminal, an attack source, an attack sample, etc.) is generated and transmitted to a security defense means on the network device for further detection and killing by the security defense means.

In a preferred embodiment, detecting metadata and determining an attack behavior comprises: detecting metadata and determining an attack behavior via a local detection engine and/or a cloud detection engine.

In a preferred embodiment, the local detection engine is employed preferably (in some environments, for example, when an external network cannot be connected to), and when an attack behavior cannot be determined, it is sent to the cloud detection engine for further detection. At this point, the cloud detection engine acts as a complement to the local detection engine.

According to any one of the above preferred embodiments or a combination of the above multiple preferred embodiments, embodiments of the invention can achieve the following beneficial effects:

According to the method for processing a network threat provided by embodiments of the invention, it can be possible to listen for the network access behavior of a network device, acquire a network datagram, extract metadata by analyzing the network datagram, and determine a known or unknown attack behavior according to detection of the metadata, which solves the problem in the prior art that the vulnerability and technique of a new network threat (comprising a known attack and an unknown attack) cannot be grasped, and then a corresponding technical means cannot be adopted to solve the new network threat. The method for processing a network threat provided by the embodiments of the invention acquires a network datagram by listening for the network access behavior of a network device in real time, can find out information such as a vulnerability attack of an unknown attack and the covert channel of the unknown attack, etc. dynamically according to the acquired network datagram, and can detect the unknown attack rapidly. In addition, the embodiments of the invention store the acquired network datagram to form historical data of a large data level, and perform analysis & mining on the large data, and then can detect an advanced covert attack, which is an effective means of performing supplementary detection on an attack missed due to the limitations of the prior art. From the above, by employing the method for processing a network threat provided by the embodiments of the invention, a new network threat, including a known attack behavior and an unknown attack behavior, can be found in time, and then a user is enabled to take a processing measure for the found new network threat, achieving the beneficial effect of ensuring that the people's production and lives and even the national security are free from network information security threats.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a device for processing a network threat according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

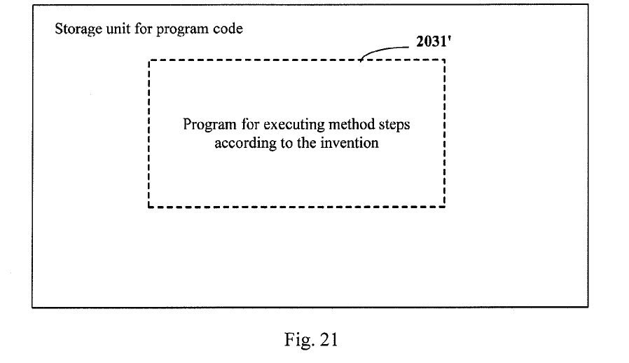

For example, FIG. 20 shows a computing device which may carry out a method for processing a network threat according to the invention. The computing device traditionally comprises a processor 2010 and a computer program product or a computer readable medium in the form of a memory 2020. The memory 2020 may be an electronic memory such as a flash memory, an EEPROM (electrically erasable programmable read-only memory), an EPROM, a hard disk or a ROM. The memory 2020 has a memory space 2030 for a program code 2031 for carrying out any method steps in the methods as described above. For example, the memory space 2030 for a program code may comprise individual program codes 2031 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 21. The storage unit may have a memory segment, a memory space, etc. arranged similarly to the memory 2020 in the computing device of FIG. 20. The program code may for example be compressed in an appropriate form. In general, the storage unit comprises a computer readable code 2031′, i.e., a code which may be read by e.g., a processor such as 2010, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for processing a network threat comprising:
listening for a network access behavior of a network device and acquiring a network datagram;
analyzing the acquired network datagram to extract metadata; and
detecting the metadata and determining an attack behavior, wherein the attack behavior comprises a known attack behavior and/or an unknown attack behavior.

2. The method as claimed in claim 1, wherein the analyzing the acquired network datagram comprises:
classifying the acquired network datagram; and
selecting a corresponding policy to detect an attack behavior for each class.

3. The method as claimed in claim 2, wherein the classifying the acquired network datagram comprises:
dividing the acquired data into a file-typed datagram and/or a non-file-typed datagram according to the attributes of network datagrams.

4. The method as claimed in claim 3, wherein the selecting a corresponding policy to detect an attack behavior for each class comprises:
for the file-typed datagram, restoring it to a file; and
detecting the restored file, to detect whether the file has a malicious behavior.

5. The method as claimed in claim 4, wherein the detecting the restored file comprises: utilizing a sandbox detection mode to detect the restored file.

6. The method as claimed in claim 4, wherein the detecting whether the file has a malicious behavior comprises:
detecting whether the file has a malicious behavior based on the principle of network abnormal behavior detection.

7. The method as claimed in claim 3, wherein the selecting a corresponding policy to detect an attack behavior for each class comprises:
for the non-file-typed datagram, detecting an attack behavior based on the principle of network abnormal behavior detection.

8. The method as claimed in claim 7, wherein the detecting an attack behavior based on the principle of network abnormal behavior detection comprises:
extracting network behavior information of the metadata;
conducting multidimensional network behavior statistics for the network behavior information;
establishing a network abnormal behavior model utilizing decision tree classification rules according to the statistical result; and
determining an attack behavior by using the network abnormal behavior model.

9. The method as claimed in claim 1, further comprising: performing full flow storage for the captured network datagram for use for subsequent analysis.

10. The method as claimed in claim 9, further comprising: performing attack detection based on big data analysis on stored network datagrams to determine an attack behavior when the order of magnitude of the stored network datagrams arrives at big data level; and/or for a determined attack behavior, backtracking the attack behavior based on big data analysis.

11. The method as claimed in claim 10, wherein the operation of backtracking the attack behavior based on big data analysis comprises at least one of the following: locating an attack source of the attack behavior; restoring an access behavior corresponding to the attack behavior; and restoring access content corresponding to the attack behavior.

12. The method as claimed in claim 1, wherein after detecting the metadata and determining an attack behavior, there is further comprised, upgrading a security means used on the network device according to an unknown attack behavior, such that it can defend against the unknown attack behavior.

13. The method as claimed in claim 1, wherein the detecting the metadata and determining an attack behavior comprises: detecting the metadata and determining an attack behavior via a local detection engine and/or a cloud detection engine.

14. A device for processing a network threat comprising:
a memory having instructions stored thereon;
a processor configured to execute the instructions to perform operations for processing a network threat, comprising:
listening for a network access behavior of a network device and acquiring a network datagram;
analyzing the acquired network datagram to extract metadata; and
detecting the metadata and determining an attack behavior, wherein the attack behavior comprises a known attack behavior and/or an unknown attack behavior.

15-21. (canceled)

22. The device as claimed in claim 14, the operations further comprising: performing full flow storage for the captured network datagram for use for subsequent analysis.

23. The device as claimed in claim 22, the operations further comprising: performing attack detection based on big data analysis on stored network datagrams to determine an attack behavior when the order of magnitude of the stored network datagrams arrives at big data level; and/or for a determined attack behavior, backtracking the attack behavior based on big data analysis.

24. The device as claimed in claim 23, wherein the operation of backtracking the attack behavior based on big data analysis comprises at least one of the following: locating an attack source of the attack behavior; restoring an access behavior corresponding to the attack behavior; and restoring access content corresponding to the attack behavior.

25. The device as claimed in claim 14, the operations further comprising: after detecting the metadata and determining an attack behavior, upgrading a security means used on the network device according to an unknown attack behavior, such that it can defend against the unknown attack behavior.

26. The device as claimed in claim 14, wherein the operation of detecting metadata and determining an attack behavior comprises: detecting the metadata and determining an attack behavior via a local detection engine and/or a cloud detection engine.

27. (canceled)

28. A non-transitory computer readable medium storing computer program comprising computer readable codes, and running of said computer readable codes on a computing device causes said device to carry out operations for processing a network threat, the operations comprising:
listening for a network access behavior of a network device and acquiring a network datagram;
analyzing the acquired network datagram to extract metadata; and
detecting the metadata and determining an attack behavior, wherein the attack behavior comprises a known attack behavior and/or an unknown attack behavior.
